(19) United States
(12) Patent Application Publication
(10) Pub. No.: US 2004/0100886 A1
(43) Pub. Date: May 27, 2004

(54) Optical drive with switching rotational speeds and switching method thereof

(75) Inventor: Wei-Tse Hsu, Taipei City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/715,925

(22) Filed: Nov. 17, 2003

(30) Foreign Application Priority Data
Nov. 21, 2002 (TW) 91133955

(51) Int. Cl. G11B 7/00

(52) U.S. Cl. 369/53.3

(57) ABSTRACT

A method for changing rotational speeds of a optical drive. First, a reading speed for software to read data from a disc in the optical drive is detected. Then, whether the reading speed exceeds a critical speed is determined. The critical speed is less than the lowest rotational speed of the optical drive to process a read command and exceeding a reading speed for the optical drive to process a play command. If the reading speed exceeds the critical speed, the rotational speed of the optical drive reading an audio disc or a video compact disc is changed to a high speed. If the reading speed is less than the critical speed, the rotational speed of the optical drive reading an audio disc or a video compact disc is changed to a low speed.

### BACKGROUND OF THE INVENTION

1. Field of the Invention

The present invention relates to an application for an optical drive and particularly to a method for changing rotational speeds of an optical drive by detecting a speed for the optical drive reading data and an optical drive using the method.

2. Description of the Prior Art

Software uses PLAY commands to read audio data from an audio disc in an optical drive, for example a CD-ROM drive, and outputs the audio data at a low speed. The software uses READ commands to read audio data from the audio disc and outputs the audio data to a central processing unit through an IDE interface. Data using READ commands to read from CD-ROM drivers is usually stored in a hard disc or recorded in CD-RW drivers. Using faster speeds to read data can save a lot of time for users. Thus, reading speed of CD-ROM drivers for READ commands is much faster than that for PLAY commands. For example, to execute audio commands, a CD-ROM drive uses low CAV (Constant Angular Velocity) to read an audio disc. The rotational speed on the maximum circle of the CD-ROM drive is 5× CAV and on the minimum circle of the CD-ROM drive is 2× CAV. For read audio commands, the CD-ROM drive uses high CAV to read an audio disc. The rotational speed on the maximum circle of the CD-ROM drive is 24× CAV and on the minimum circle of the CD-ROM drive is 10× CAV. In other words, for PLAY commands, an motor module of the CD-ROM drive rotates at a low speed and for READ commands, the motor module rotates at a higher speed.

In the Windows Media Player, produced by Microsoft, for example, a computer uses READ commands to read audio data from an audio disc in a CD-ROM drive. Then, the audio data is stored into registers or hard disks before it plays. After processing the audio data, the computer outputs audio from a sound card at a lower speed compared with the reading speed. Reading audio data from the CD-ROM drive at a high speed is easily generates noise. The motor module of the CD-ROM drive operating at the high speed for a long time is also easily worn. Furthermore, high speeds reading disks which are low quality can decrease accuracy of the data read, and retry operations are intrusive and inconvenient.

The computer also uses READ commands to read video data from video discs in the CD-ROM drive. After processing the video data, the computer outputs video signal at a low speed. Reading video data from the CD-ROM drive at a high speed for outputting video signal at the low speed also easily generates considerable noise.

### SUMMARY OF THE INVENTION

The object of the present invention is to provide a method for changing rotational speeds of an optical drive the rotational speed of the optical drive is changed according to commands for software to read data from a disc in the optical drive, which may be play or extraction commands.

An object of the present invention is to provide a optical drive with switchable rotational speeds. For PLAY commands, the optical drive uses a low rotational speed to read data to save power, decrease noise and increase lifetime of an motor module of the optical drive. For READ commands, the optical drive uses a high rotational speed to read data to enhance user convenience.

The present invention provides a method for changing rotational speeds of a optical drive. First, a reading speed for software to read data from a disc in the optical drive is detected. Then, whether the reading speed exceeds a critical speed is determined. The critical speed is less than the lowest rotational speed of the optical drive to process a READ command and exceeding a reading speed for the optical drive to process a PLAY command. If the reading speed exceeds the critical speed, the rotational speed of the CD-ROM drive reading an audio or video disc is changed to a higher speed. If the reading speed is less than the critical speed, the rotational speed of the CD-ROM drive reading an audio disc or a video compact disc is changed to a lower speed.

The critical speed may be a range of speeds. When the reading speed is exceeded the range, the rotational speed of the CD-ROM drive reading discs is changed to the higher speed. When the reading speed is less than the range, the rotational speed of the CD-ROM drive reading discs is changed to the low speed.

Furthermore, the present invention also provides a optical drive with switchable rotational speeds, for example, a CD-ROM drive comprises a read module. The CD-ROM drive controlled by a software comprises a read module, an motor module and a control module. A disk is read by the read module. The motor module loaded with the disc rotates the disk at a rotational speed. The control module is coupled to the motor module for detecting a reading speed for reading data from the disc, determining whether the reading speed corresponding to the rotational speed of the CD-ROM drive exceeds a critical speed and changing the rotational speed of the CD-ROM drive according to the determined result of the reading speed and the critical speed. When the reading speed corresponding to the rotational speed of the CD-ROM drive exceeds the critical speed, the control module changes the rotational speed of the CD-ROM drive to a high speed. When the reading speed corresponding to the rotational speed of the CD-ROM drive is less than the critical speed, the control module changes the rotational speed of the CD-ROM drive to a low speed. The critical speed is less than the lowest rotational speed of the CD-ROM drive to process a READ command and exceeding a reading speed for the CD-ROM drive to process a PLAY command.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a flowchart of a method for changing rotational speeds of a CD-ROM drive according to the first embodiment of the present invention.

FIG. 2 is a block diagram illustrating a CD-ROM drive with switchable rotational speeds according to the first embodiment of the present invention.

FIGS. 3a and 3b are flowcharts of the method for changing rotational speeds of the CD-ROM drive according to the second embodiment of the present invention.

### DETAILED DESCRIPTION OF THE INVENTION

A method for changing rotational speeds of a optical drive is first provided by the invention. Using the method, the rotational speed of the optical drive is changed according to commands for software to read data from a disc in the optical drive, which may be play or extraction commands. The method is used when the optical driver read audio discs or video discs. The optical driver reading audio discs is used as an example to illustrate the following embodiments.

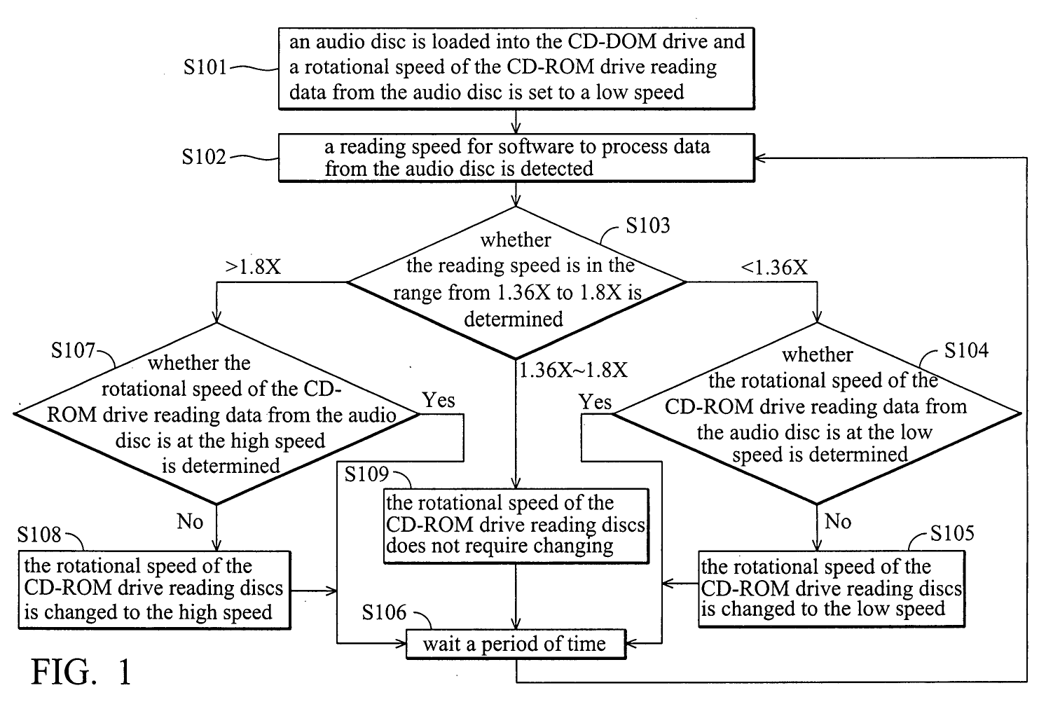

FIG. 1 shows a flowchart of a method for changing rotational speeds of an optical drive, for example a CD-ROM drive, according to the first embodiment of the present invention. First, an audio disc is loaded into the CD-ROM drive and a rotational speed of the CD-ROM drive reading data from the audio disc is set to a low speed (S101). In the embodiment, to execute audio commands, the rotational speed of the CD-ROM drive is assumed to be low speed i.e., the rotational speed on the maximum circle of the CD-ROM drive is 5× CAV (Constant Angular Velocity) and on the minimum circle of the CD-ROM drive is 2× CAV. For read audio commands, the rotational speed of the CD-ROM drive is assumed to be a high speed i.e. the rotational speed on the maximum circle of the CD-ROM drive is 24× CAV (Constant Angular Velocity) and on the minimum circle of the CD-ROM drive is 10× CAV.

Then, a reading speed for software to process data from the audio disc is detected (S102). Next, whether the reading speed is in the range from 1.36× to 1.8× is determined (S103). The determining step (S103) comprises calculating a number of frames read in a predetermined period and, according to the amount, calculating the relationship between the reading speed and the rotational speed of the CD-ROM drive. For example, if the number of frames is 75 and the predetermined period is 1 second, the reading speed is equal to the 1× rotational speed of the CD ROM drive. The predetermined period is exceeded in 1 second. In the embodiment, if the predetermined period is 5 seconds and the number of frames is in a range from 512 to 675, the rotational speed of the CD-ROM drive is between the speed of 1.36× and 1.8×.

If the reading speed is not in the range from 1.36× to 1.8× and less than 1.36×, whether the rotational speed of the CD-ROM drive reading data from the audio disc is at the low speed is determined (S104). If the rotational speed of the CD-ROM drive is not at the low speed, the rotational speed of the CD-ROM drive reading discs is changed to the low speed (S105). After a period of time (S106), step S102 is repeated. If the rotational speed of the CD-ROM drive is at the low speed, after the period of time (S106), step S102 is repeated.

If the reading speed is not in the range from 1.36× to 1.8× and exceeded in 1.8×, whether the rotational speed of the CD-ROM drive reading data from the audio disc is at the high speed is determined (S107). If the rotational speed of the CD-ROM drive is not at the high speed, the rotational speed of the CD-ROM drive reading discs is changed to the high speed (S108). After waiting the period of time (S106), step S102 is repeated. If the rotational speed of the CD-ROM drive is at the high speed, after the period of time (S106), step S102 is repeated.

If the reading speed is in the range from 1.36× to 1.8×, the rotational speed of the CD-ROM drive reading discs does not require changing (S109). After waiting the period of time (S106), step S102 is repeated.

The above procedures can be performed in a program stored in a computer.

The range from 1.36× to 1.8× is used as an example of a critical speed to determine whether the command for the software to process data from the audio disc is play or extraction commands. Other ranges can be used as long as the speeds in the range are less than the lowest rotational speed of the CD-ROM drive to process read commands (such as 2× in the embodiment) and exceeding a reading speed for the CD-ROM drive to process play commands (such as 1× in the embodiment).

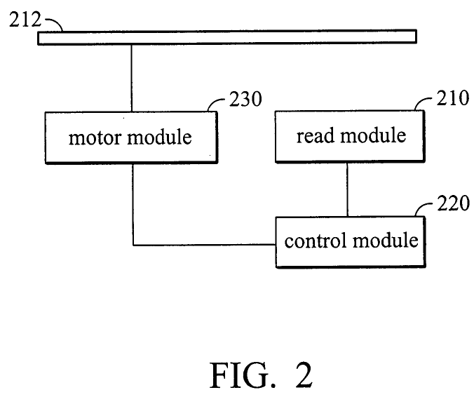

FIG. 2 is a block diagram illustrating a CD-ROM drive with switchable rotational speeds according to the first embodiment of the present invention. The CD-ROM driver comprises a read module 210, a control module 220, and an motor module 230. Data stored in an audio disk 212 is read by the read module 210. The data read from the read module 210 is transmitted to the control module 220. According to the speed for reading data, the control module 220 controls the rotational speed of the motor module 230. The motor module 230 loaded with the audio disc 212 rotates the audio disk 212 at a rotational speed. To execute audio commands, the rotational speed of the CD-ROM drive is assumed to the low speed i.e., the rotational speed on the maximum circle of the CD-ROM drive is 5× CAV (Constant Angular Velocity) and on the minimum circle of the CD-ROM drive is 2× CAV.

For read audio commands, the rotational speed of the CD-ROM drive is assumed to be a high speed i.e. the rotational speed on the maximum circle of the CD-ROM drive is 24× CAV (Constant Angular Velocity) and on the minimum circle of the CD-ROM drive is 10× CAV.

The control module 230 detects a reading speed of the read module 210. Reading is also a software processing data from the audio disc 212. The control module 230 determines whether the reading speed is in the range from 1.36× to 1.8×.

If the reading speed is not in the range from 1.36× to 1.8× and less than 1.36×, the control module 230 first determines whether the rotational speed of the motor module 230 is at the low speed. If the rotational speed of the motor module 230 is not at the low speed, the control module 230 changes the rotational speed of the motor module 230 to the low speed. After a period of time, the control module 230 detects a reading speed for reading data from the audio disc 212 again. If the rotational speed of the motor module 230 is at the low speed, after the period of time, the control module 230 detects a reading speed for reading data from the audio disc 212 again.

If the reading speed is not in the range from 1.36× to 1.8× and exceeded in 1.8×, the control module 230 first determines whether the rotational speed of the motor module 230 is at the high speed. If the rotational speed of the motor module 230 is not at the high speed, the control module 230 changes the rotational speed of the motor module 230 to the high speed. After a period of time, the control module 230 detects a reading speed for reading data from the audio disc 212 again. If the rotational speed of the motor module 230 is at the high speed, after the period of time, the control module 230 detects a reading speed for reading data from the audio disc 212 again.

If the reading speed is in the range from 1.36× to 1.8×, the rotational speed of the motor module 230 does not require changing. After waiting the period of time, step S102 is repeated.

The range from 1.36× to 1.8× is used as an example for a critical speed to determine whether the command for the read module 210 to process data from the audio disc 212 is play or extraction commands. Other ranges can be used as long as the speeds in the range are less than the lowest rotational speed of the CD-ROM drive to process read commands (such as 2× in the embodiment) and exceeding a reading speed for the CD-ROM drive to process play commands (such as 1× in the embodiment).

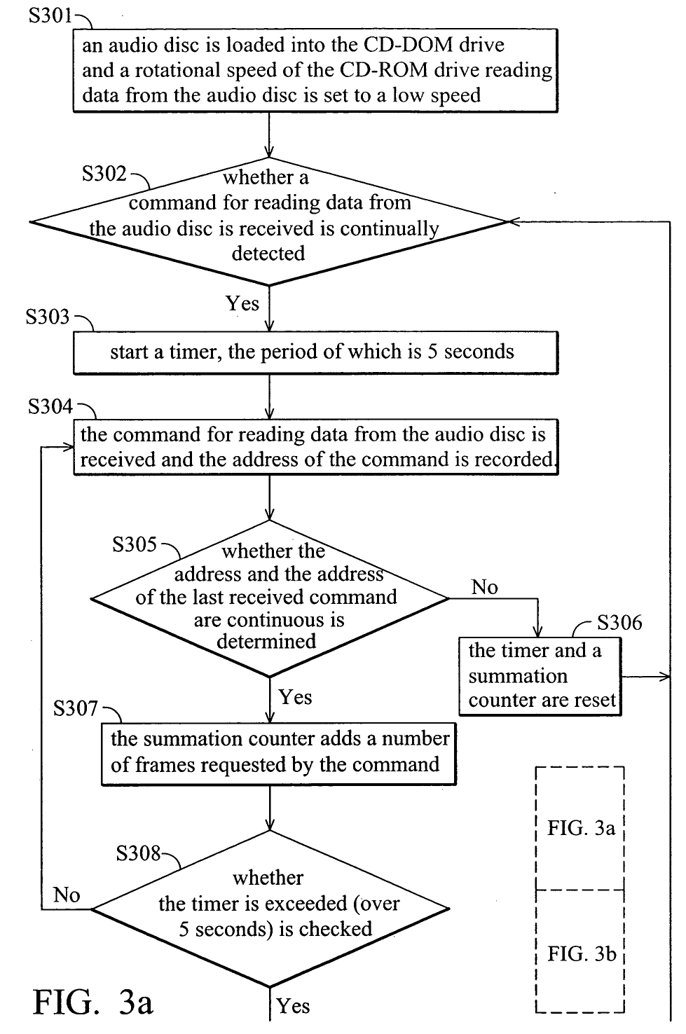

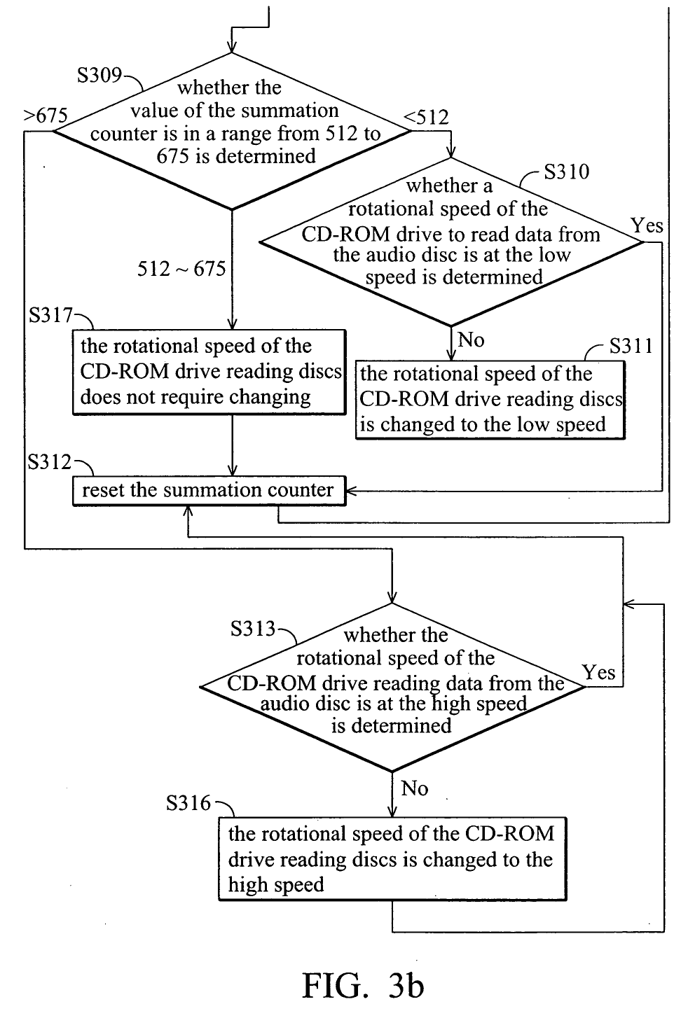

FIGS. 3a and 3b are flowcharts of the method for changing rotational speeds of the CD-ROM drive according to the second embodiment of the present invention. First, an audio disc is loaded into the CD-DOM drive and a rotational speed of the CD-ROM drive reading data from the audio disc is set to a low speed (S301). In the embodiment, to execute audio commands, the rotational speed of the CD-ROM drive is assumed to the low speed i.e., the rotational speed on the maximum circle of the CD-ROM drive is 5× CAV (Constant Angular Velocity) and on the minimum circle of the CD-ROM drive is 2× CAV. For read audio commands, the rotational speed of the CD-ROM drive is assumed to be a high speed i.e. the rotational speed on the maximum circle of the CD-ROM drive is 24× CAV (Constant Angular Velocity) and on the is minimum circle of the CD-ROM drive is 10× CAV.

Then, whether a command for reading data from the audio disc is received is continually detected (S302). After receiving the command, a timer is started (S303). The period of the timer is 5 seconds. During the period, the following procedures are repeated. The command for reading data from the audio disc is received and the address of the command is recorded (S304). Whether the address and the address of the last received command are continuous is determined (S305). If they are not continuous, the timer and a summation counter are reset (S306). Step S302 is repeated. If they are continuous, the summation counter adds a number of frames requested by the command (S307).

Whether the timer is exceeded (over 5 seconds) is checked (S308). If the timer is not exceeded, step S304 is repeated. If the timer is exceeded, whether the value of the summation counter is in a range from 512 to 675 is determined (S309).

If the value of the summation counter is not in a range from 512 to 675 and less than 512 i.e. the reading speed for the software to process data from the audio disc is less than 1.36×, whether a rotational speed of the CD-ROM drive to read data from the audio disc is at the low speed is determined (S310). If the rotational speed of the CD-ROM drive is not at the low speed, the rotational speed of the CD-ROM drive reading discs is changed to the low speed (S311). After resetting the summation counter (S312), step S302 is repeated. If the rotational speed of the CD-ROM drive is at the low speed, after resetting the summation counter (S312), step S302 is repeated.

If the value of the summation counter is not in a range from 512 to 675 and exceeded in 675 i.e. the reading speed for the software to process data from the audio disc is exceeded in 1.8×, whether the rotational speed of the CD-ROM drive reading data from the audio disc is at the high speed is determined (S313). If the rotational speed of the CD-ROM drive is not at the high speed, the rotational speed of the CD-ROM drive reading discs is changed to the high speed (S316). After resetting the summation counter (S312), step S302 is repeated. If the rotational speed of the CD-ROM drive is at the high speed, after resetting the summation counter (S312), step S302 is repeated.

If the value of the summation counter is not in a range from 512 to 675 i.e. the reading speed is in the range from 1.36× to 1.8×, the rotational speed of the CD-ROM drive reading discs does not require changing (S317). After resetting the summation counter (S312), step S302 is repeated.

The range from 1.36× to 1.8× is used as an example for a critical speed to determine whether the command for the software to process data from the audio disc is play or extraction commands. Other ranges can be used as long as the speeds in the range are less than the lowest rotational speed of the CD-ROM drive to process read commands (such as 2× in the embodiment) and exceeding a reading speed for the CD-ROM drive to process play commands (such as 1× in the embodiment).

Using the method for changing rotational speeds of a CD-ROM drive provided by the invention, the rotational speed of the CD-ROM drive is changed according to commands for software to read data from a disc in the CD-ROM drive, which may be play or extraction commands. For play commands, the CD-ROM drive uses a low rotational speed to read data to save power, decrease noise and increase use time of an motor module of the CD-ROM drive. For read commands, the CD-ROM drive uses a high rotational speed to read data to save users' time.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for changing a rotational speed of an optical drive comprising:
detecting a reading speed for a software processing data from a disc in the optical drive;
determining whether the reading speed corresponding to a rotational speed of the optical drive exceeds a critical speed, wherein the critical speed is less than the lowest rotational speed of the optical drive to process a read command and exceeding a reading speed for the optical drive to process a play command; and
changing the rotational speed of the optical drive according to the determined result of the reading speed and the critical speed.

2. The method as claimed in claim 1, wherein the changing step comprises:
when the reading speed corresponding to the rotational speed of the optical drive exceeds the critical speed, changing the rotational speed of the optical drive to a high speed; and
when the reading speed corresponding to a rotational speed of the optical drive is less than the critical speed, changing the rotational speed of the optical drive to a low speed.

3. The method as claimed in claim 1, wherein the determining step further comprises:
calculating a number of frames read in a predetermined period; and
according to the amount, calculating the relationship between the reading speed and the rotational speed of the optical drive.

4. The method as claimed in claim 3, wherein when the number of frames is 75 and the predetermined period is 1 second, the reading speed is equal to 1 times the rotational speed of the CD ROM drive.

5. The method as claimed in claim 3 further comprising:
determining whether the two continuous frames comprise two continuous data according to addresses of the optical drive where the frame read the data;
when the continuous frames do not comprise continuous data, resetting the number of frames read and the predetermined period.

6. The method as claimed in claim 2, wherein when the optical drive reads an audio disc, the high speed is 10-24× CAV (Constant Angular Velocity) wherein the rotational speed on the maximum circle of the optical drive is 24× CAV and on the minimum circle of the optical drive is 10× CAV and the low speed is 2-5× CAV wherein the rotational speed on the maximum circle of the optical drive is 5× CAV and on the minimum circle of the optical drive is 2× CAV.

7. The method as claimed in claim 2, wherein when the optical drive reads a video compact disc, the high speed is 10-24× CAV wherein the rotational speed on the maximum circle of the optical drive is 24× CAV and on the minimum circle of the optical drive is 10× CAV and the low speed is 2-5× CAV wherein the rotational speed on the maximum circle of the optical drive is 5× CAV and on the minimum circle of the optical drive is 2× CAV.

8. The method as claimed in claim 1, wherein the reading speed for the optical drive to process the play command is 1×.

9. The method as claimed in claim 1, wherein the lowest rotational speed of the optical drive to process the read command is 2×.

10. A optical drive with switchable rotational speeds, the optical drive controlled by a software, comprising:
a read module for reading a disk;
an motor module loaded with the disc for rotating the disk at a rotational speed; and
a control module coupled to the motor module for detecting a reading speed for the software processing data from the disc, determining whether the reading speed corresponding to a rotational speed of the optical drive exceeds a critical speed and changing the rotational speed of the optical drive according to the determined result of the reading speed and the critical speed;
wherein the critical speed is less than the lowest rotational speed of the optical drive to process a read command and exceeding a reading speed for the optical drive to process a play command.

11. The optical driver as claimed in claim 10, wherein when the reading speed corresponding to the rotational speed of the optical drive exceeds the critical speed, the control module changes the rotational speed of the optical drive to a high speed and when the reading speed corresponding to the rotational speed of the optical drive is less than the critical speed, the control module changes the rotational speed of the optical drive to a low speed.

12. The optical driver as claimed in claim 10, wherein when the optical drive reads an audio disc, the high speed is 10-24× CAV (Constant Angular Velocity) wherein the rotational speed on the maximum circle of the optical drive is 24× CAV and on the minimum circle of the optical drive is 10× CAV and the low speed is 2-5× CAV wherein the rotational speed on the maximum circle of the optical drive is 5× CAV and on the minimum circle of the optical drive is 2× CAV.

13. The optical driver as claimed in claim 10, wherein when the optical drive reads a video compact disc, the high speed is 10-24× CAV wherein the rotational speed on the maximum circle of the optical drive is 24× CAV and on the minimum circle of the optical drive is 10× CAV and the low speed is 2-5× CAV wherein the rotational speed on the maximum circle of the optical drive is 5× CAV and on the minimum circle of the optical drive is 2× CAV.

14. The optical driver as claimed in claim 10 wherein the reading speed for the optical drive to process the play command is 1×.

15. The optical driver as claimed in claim 10 wherein the lowest rotational speed of the optical drive to process the read command is 2×.
